(19) United States
(12) Patent Application Publication
(10) Pub. No.: US 2015/0296725 A1
(43) Pub. Date: Oct. 22, 2015

(54) Aeroponic and Drip Gardener System

(71) Applicant: Leslie Dennis Mong, Aberdeen, WA (US)

(72) Inventor: Leslie Dennis Mong, Aberdeen, WA (US)

(21) Appl. No.: 14/690,132

(22) Filed: Apr. 17, 2015

Related U.S. Application Data
(60) Provisional application No. 61/981,523, filed on Apr. 18, 2014.

(51) Int. Cl. A01G 31/02

(52) U.S. Cl. CPC A01G 31/02

(57) ABSTRACT

An aeroponic and drip gardener system is a system for supporting as well as delivering water and nutrients to a plant without the use of a growing medium. The system features an at least one aeroponic assembly through which water and nutrients from a fluid reservoir are delivered to a plant by a pump. The plant is held in place within an aeroponic container by a plant-supporting gasket in a manner such that the plant roots are freely hanging within the aeroponic container. Water and nutrients move through a distribution pipe and are distributed directly to the plant roots by an at least one spray nozzle assembly. The system includes a drainage system through which any remaining water and nutrients are able to return to the fluid reservoir. Water and nutrients are able to return to the fluid reservoir via a return pipe.

The current application claims a priority to the U.S. Provisional Patent application Ser. No. 61/981,523 filed on Apr. 18, 2014.

### FIELD OF THE INVENTION

The present invention relates generally to an aeroponic system for growing plants without a growing medium. More specifically, the present invention is an aeroponic and drip gardener system for growing and supporting a plant without a growing medium. The present invention features a drip mechanism for returning water to a reservoir without the need for a pump and additionally is designed to minimize water required to operate the present invention.

### BACKGROUND OF THE INVENTION

Aeroponic plant growing systems are often favored due to the inherent lack of need for a growing medium such as soil or water as is required in geoponic and hydroponic growing systems, respectively. Aeroponic growing systems maximize plant exposure to air in order to optimize plant growth. This is generally achieved by minimizing points of contact between plants and any support structures holding the plants in place within the systems. Because the plants in aeroponic growing systems are mostly freely suspended during growth, more natural growth and root expansion is permitted due to the lack of constraints placed on the plants as well as the maximized exposure to air. One of the most important factors to the success of any growing system as well as the health and growth of the plants is the proper drainage of the growing environment. Improper drainage of a system can result in root rot, a condition that is often lethal and untreatable. Root rot is caused by a plant's inability to acquire needed air, leading to plant decay. Root rot is commonly found in poorly drained hydroponic growing systems and resulted in the development of aeroponic growing systems that ensure that plants have sufficient access to air during growth. In an aeroponic growing system, a plant is suspended in a support structure and the roots are exposed to spray nozzles or similar mechanisms for delivering water and nutrients. The water and nutrients are generally contained within a reservoir prior to being delivered to the aeroponic growing system.

The present invention is an aeroponic and drip gardener system that is capable of providing water and nutrients to a plant. The present invention is able to physically support a plant during growth and additionally allows water to be circulated from a reservoir to the plant via a pump. The water is returned to the reservoir through gravity without need for the pump. Multiple of the present invention may be connected together in order to create a large growing system.

### BRIEF DESCRIPTION OF THE DRAWINGS

FIG. 1 is a front perspective view of the present invention.

FIG. 2 is a rear perspective view of the present invention.

FIG. 3 is a perspective view of the aeroponic container.

FIG. 4 is a perspective view of the aeroponic container and the aeroponic lid.

FIG. 5 is a perspective view of the structural base.

FIG. 6 is a perspective view of the structural base and the drainage lid.

FIG. 7 is an exploded perspective view of the present invention.

FIG. 8 is a bottom schematic view of two interconnected instances of the present invention displaying connections between a first aeroponic assembly and a second aeroponic assembly.

FIG. 9 is a bottom schematic view of three interconnected instances of the present invention displaying connections between an arbitrary aeroponic assembly, a preceding aeroponic assembly, and a subsequent aeroponic assembly.

### DETAIL DESCRIPTIONS OF THE INVENTION

All illustrations of the drawings are for the purpose of describing selected versions of the present invention and are not intended to limit the scope of the present invention.

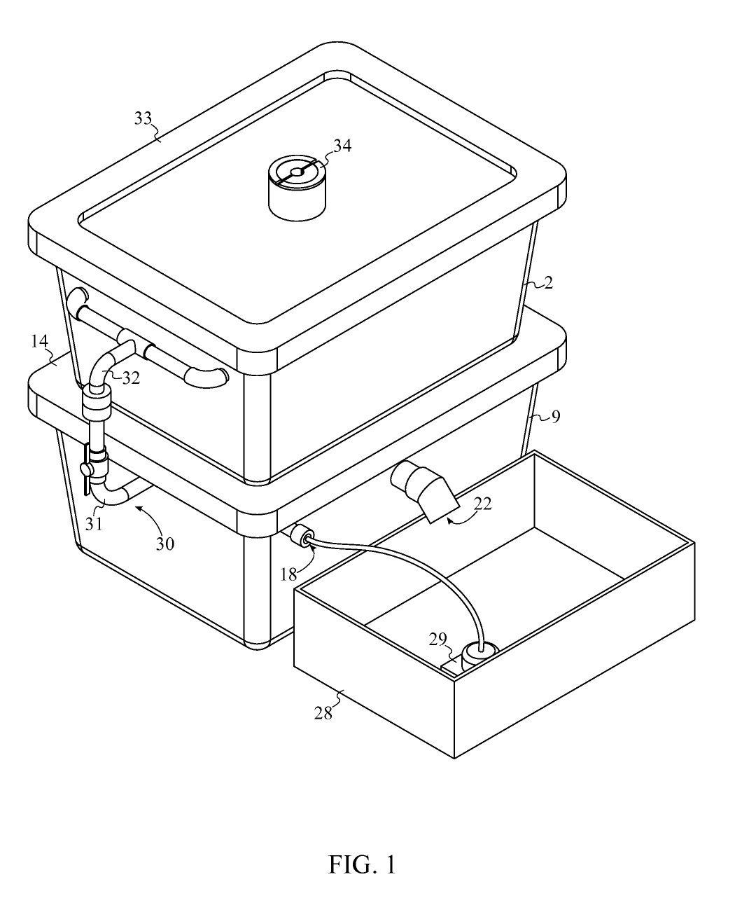

The present invention is an aeroponic and drip gardener system that supports and provides water and nutrients to a plant. The present invention is shown in FIGS. 1-7 and comprises an at least one aeroponic assembly 1, a fluid reservoir 28, and a pump 29.

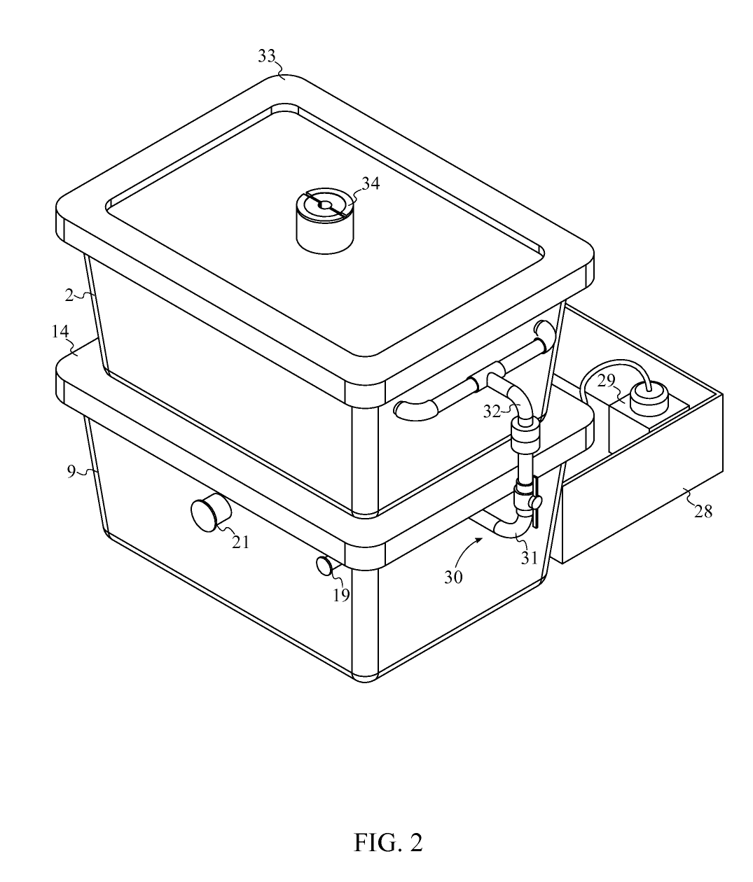

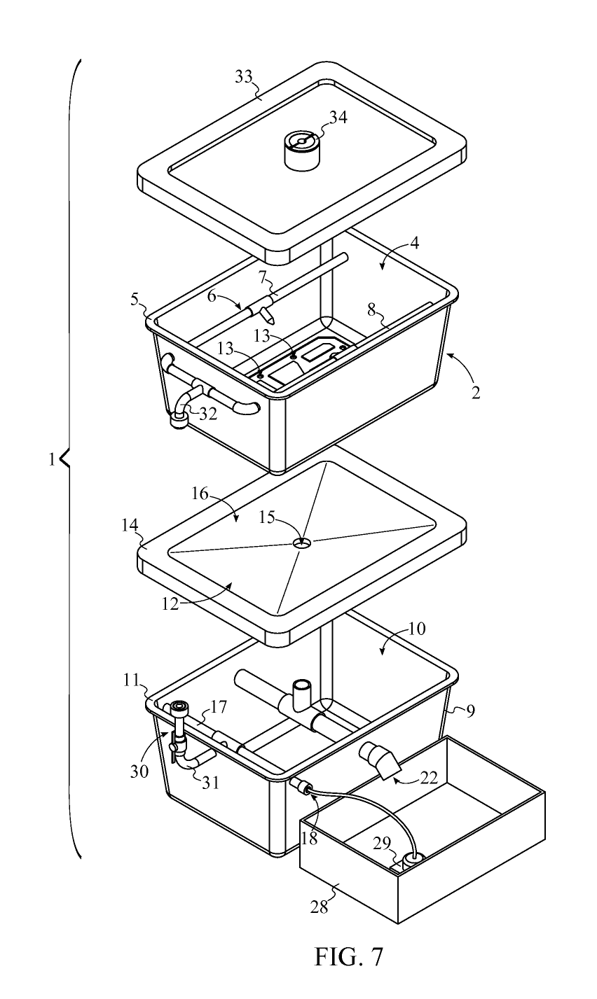

With reference to FIG. 1, FIG. 2, and FIG. 7, the at least one aeroponic assembly 1 is the system that supports the plant as well as delivers water and nutrients to the plant. The fluid reservoir 28 stores water and nutrients that are delivered to the at least one aeroponic assembly 1 by the pump 29. The pump 29 is mounted within the fluid reservoir 28 in order to allow the pump 29 to direct the flow of water and nutrients into the at least one aeroponic assembly 1.

Referring to FIGS. 1-7, the at least one aeroponic assembly 1 comprises an aeroponic container 2, an at least one spray nozzle assembly 6, a structural base 9, a drainage system 12, a distribution pipe 17, and a return pipe 20. The aeroponic container 2 houses the plant roots while the at least one spray nozzle assembly 6 directs water and nutrients from the fluid reservoir 28 to the plant roots. The structural base 9 is the base onto which the distribution pipe 17 and the return pipe 20 are mounted. The distribution pipe 17 is the pipe through which water and nutrients are drawn from the fluid reservoir 28 before entering the aeroponic container 2. The return pipe 20 is the pipe through which remaining water and nutrients are able to return from the aeroponic container 2 to the fluid reservoir 28. In the preferred embodiment of the present invention, the distribution pipe 17 and the return pipe 20 extend outward from the structural base 9 allowing multiple of the present invention to be connected together.

The fluid reservoir 28 is in fluid communication with the distribution pipe 17 through the pump 29. This allows the pump 29 to direct water and nutrients from the fluid reservoir 28 into the distribution pipe 17. Additionally, the distribution pipe 17 is in fluid communication with the at least one spray nozzle assembly 6, allowing the water and nutrients to enter the at least one spray nozzle assembly 6. The at least one spray nozzle assembly 6 is mounted within the aeroponic container 2 allowing the water and nutrients from the fluid reservoir 28 to be distributed to the plant roots.

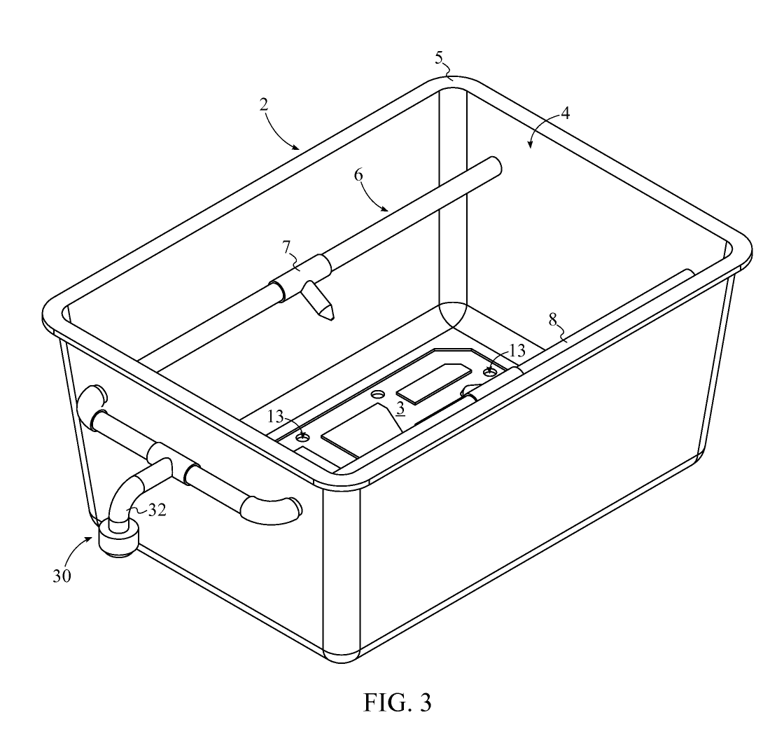

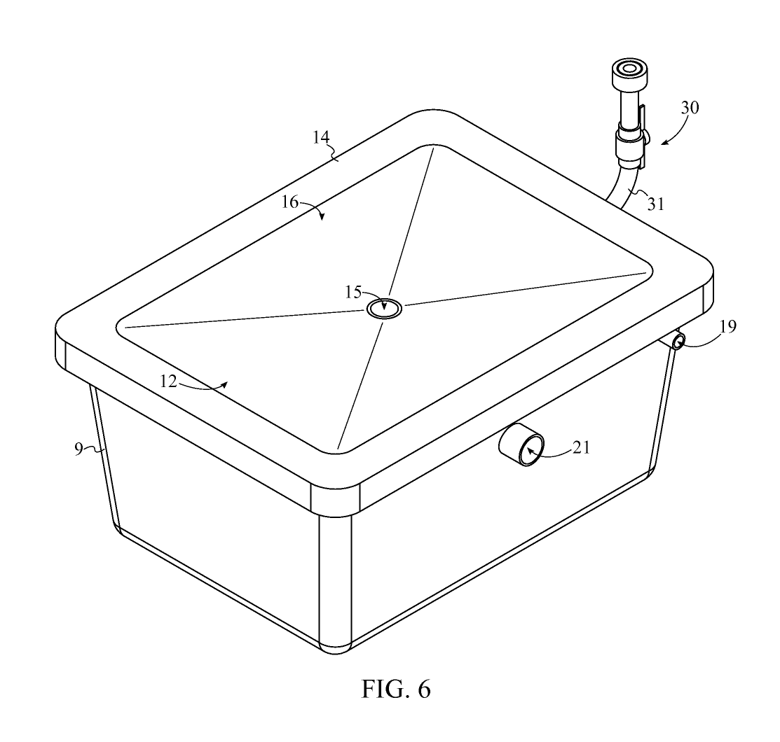

As shown in FIG. 3, FIG. 6, and FIG. 7, the drainage system 12 is the system through which remaining water and nutrients are able to return to the fluid reservoir 28 through the return pipe 20. The drainage system 12 is integrated between the aeroponic container 2 and the structural base 9. This allows remaining water and nutrients to exit the aeroponic container 2 toward the structural base 9 through the drainage system 12. The drainage system 12 is in fluid communication with the fluid reservoir 28 through the return pipe 20. As such, water and nutrients exiting the aeroponic container 2 through the drainage system 12 is able to enter the return pipe 20 and be returned to the fluid reservoir 28.

Again referring to FIGS. 1-7, the present invention further comprises a feed tube assembly 30. The feed tube assembly 30 is the conduit through which the water and nutrients are directed after exiting the distribution pipe 17 and before entering the at least one spray nozzle assembly 6. In the preferred embodiment of the present invention, the feed tube assembly 30 is externally mounted to the at least one aeroponic assembly 1. The external positioning of the feed tube assembly 30 facilitates the disassembly of the at least one aeroponic assembly 1. The feed tube assembly 30 comprises a feed inlet pipe 31 and a feed outlet pipe 32. The feed inlet pipe 31 is the pipe through which the water and nutrients are able to exit the distribution pipe 17 and as such, the distribution pipe 17 is in fluid communication with the feed inlet pipe 31. The feed inlet pipe 31 is in fluid communication with the feed outlet pipe 32 and as such, water and nutrients are able to pass from the feed inlet pipe 31 to the feed outlet pipe 32. The feed inlet pipe 31 is detachably and hermetically coupled to the feed outlet pipe 32. This allows the feed inlet pipe 31 to be separated from the feed outlet pipe 32 while allowing the feed inlet pipe 31 and the feed outlet pipe 32 to form a hermetic seal when coupled together. The feed outlet pipe 32 is in fluid communication with the at least one spray nozzle assembly 6, allowing water and nutrients to pass through the feed outlet pipe 32 and into the at least one spray nozzle assembly 6 before being distributed to the plant roots. In the preferred embodiment of the present invention, the feed tube assembly 30 may additionally feature a valve for regulating the water pressure of the at least one aeroponic assembly 1.

With reference to FIGS. 3-6, the drainage system 12 comprises a plurality of drainage holes 13, a drainage lid 14, a water-collection cavity 16, and a lid hole 15. The plurality of drainage holes 13 allows remaining water and nutrients to exit the aeroponic container 2. In the preferred embodiment of the present invention, the aeroponic container 2 comprises a container base 3. The plurality of drainage holes 13 traverses through the container base 3, allowing the water and nutrients to pass through the aeroponic container 2. The plurality of drainage holes 13 is distributed across the container base 3. This allows the water and nutrients to exit the aeroponic container 2 across the surface of the container base 3. The drainage lid 14 is the lid of the structural base 9 and as such, the drainage lid 14 is mounted onto the structural base 9. The water-collection cavity 16 is the cavity that is able to direct water and nutrients toward the lid hole 15. The water-collection cavity 16 traverses into the drainage lid 14 in order for water and nutrients to be directed by the water-collection cavity 16 after exiting the aeroponic container 2 through the plurality of drainage holes 13. Additionally, this allows the aeroponic container 2 to be seated securely into the water-collection cavity 16. The lid hole 15 is the hole through which water and nutrients are able to enter the return pipe 20 after exiting the aeroponic container 2 through the plurality of drainage holes 13. The lid hole 15 traverses through the drainage lid 14 from the water-collection cavity 16, allowing the water and nutrients to enter the lid hole 15 following direction through the water-collection cavity 16. The lid hole 15 is in fluid communication with the return pipe 20. Water and nutrients are thus able to pass through the lid hole 15 and into the return pipe 20. In the preferred embodiment of the present invention, the aeroponic container 2 may be stacked onto the drainage lid 14 and the structural base 9. As such, the aeroponic container 2 is mounted onto the drainage lid 14, adjacent to the water-collection cavity 16.

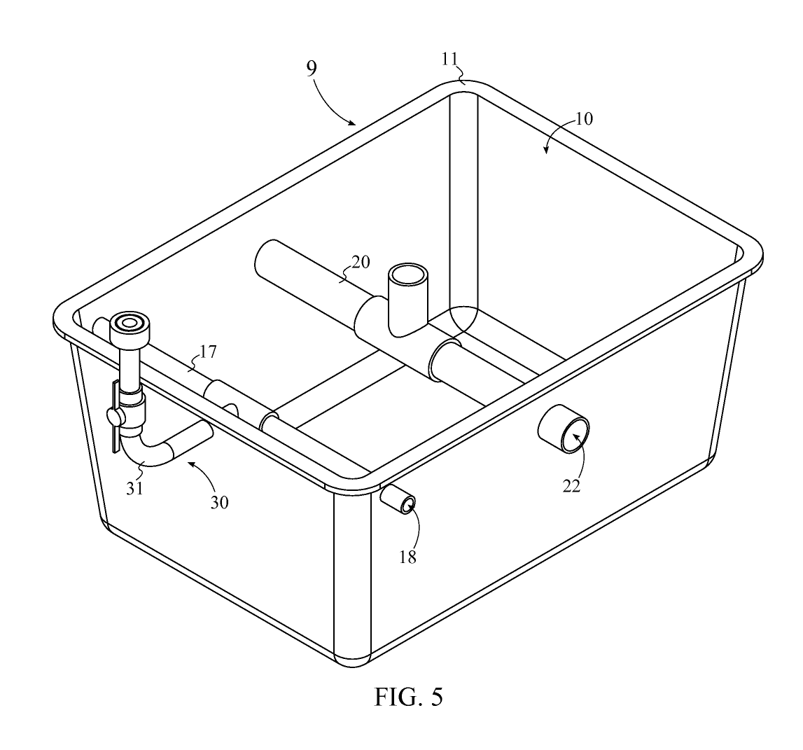

In the preferred embodiment of the present invention, the structural base 9 is an open-ended vessel as shown in FIG. 5. This increases the accessibility of the interior of the structural base 9. The open-ended vessel comprises a vessel open end 10 and a vessel lip 11. The vessel open end 10 is the end of the open-ended vessel 9 through which the interior of the open-ended vessel is accessible. The vessel lip 11 is the lip onto which the drainage lid 14 may be mounted as shown in FIG. 6. The vessel lip 11 is laterally positioned around the vessel open end 10, allowing the drainage lid 14 to be mounted over the vessel open end 10. The drainage lid 14 is seated onto the vessel lip 11, allowing the drainage lid 14 to entirely cover the vessel open end 10.

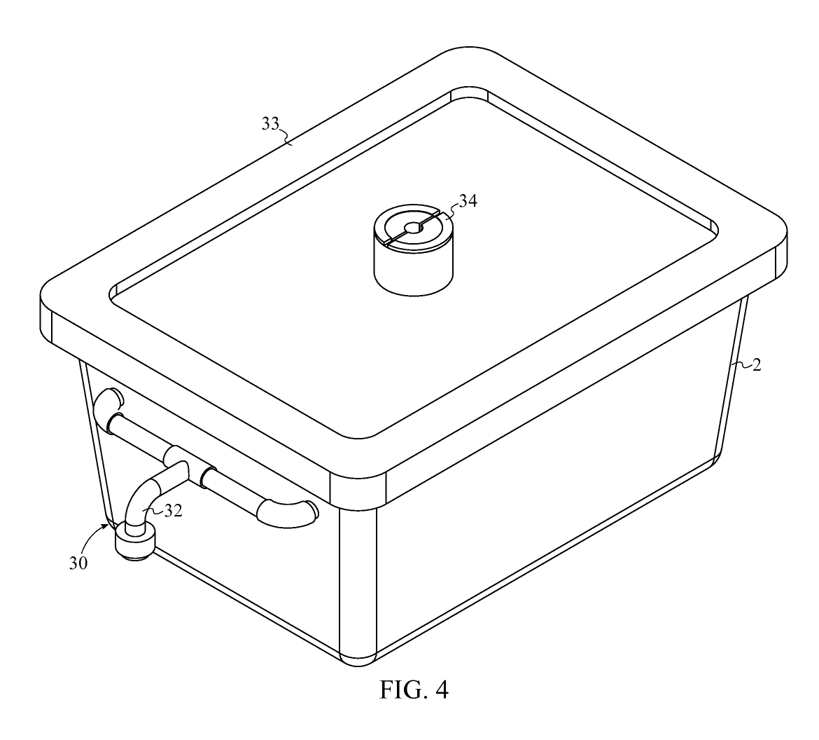

With reference to FIG. 3 and FIG. 4, the present invention further comprises an aeroponic lid 33. The aeroponic lid 33 is similar to the drainage lid 14 and serves as the lid for the structural base 9. Similar to the structural base 9, the aeroponic container 2 comprises a container open end 4 and a container lip 5. The container open end 4 provides access to the interior of the aeroponic container 2 while the container lip 5 is the lip onto which the aeroponic lid 33 may be mounted. The container lip 5 is laterally positioned around the container open end 4 and as such, the aeroponic lid 33 may be mounted over the vessel open end 10. The aeroponic lid 33 is seated onto the container lip 5, similar to the drainage lid 14.

In addition to covering the container open end 4, the aeroponic lid 33 is the lid through which the plant is mounted onto the aeroponic container 2. The present invention further comprises a plant-supporting gasket 34. The plant-supporting gasket 34 provides structural support for the plant by holding the plant in place. The plant-supporting gasket 34 is positioned centrally on the aeroponic lid 33 and traverses into the aeroponic container 2 through the aeroponic lid 33, allowing the plant to be held in place with the plant roots freely suspended within the aeroponic container 2. Contact points between the plant-supporting gasket 34 and the plant are minimized. This allows the at least one spray nozzle assembly 6 to distribute water and nutrients directly to the plant roots and additionally allows the roots to grow evenly through the container. The plant-supporting gasket 34 is removably attached to the aeroponic lid 33. This facilitates removal of the plant from the aeroponic container 2 as needed.

As shown in FIG. 3 and FIG. 7, in the preferred embodiment of the present invention, the at least one spray nozzle assembly 6 comprises a first spray nozzle assembly 7 and a second spray nozzle assembly 8. The first spray nozzle assembly 7 and the second spray nozzle assembly 8 allow water and nutrients to be delivered to the plant roots from two directions. As such, the first spray nozzle assembly 7 and the second spray nozzle assembly 8 are positioned opposite to each other across the aeroponic container 2. Additionally, the first spray nozzle assembly 7 and the second spray nozzle assembly 8 are oriented toward each other, allowing the water and nutrients to be delivered to the plant roots from two directions.

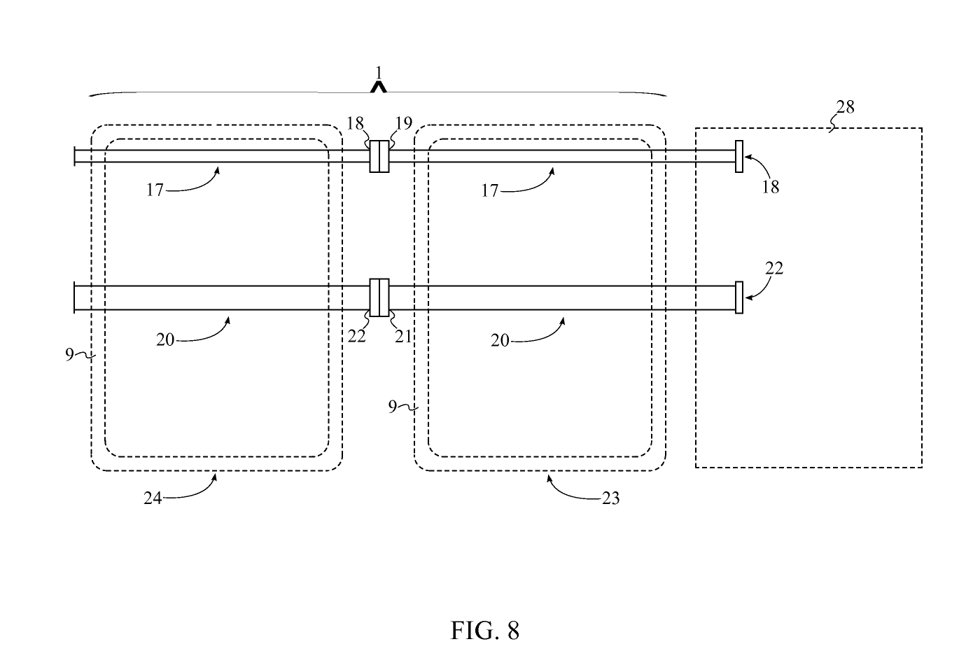

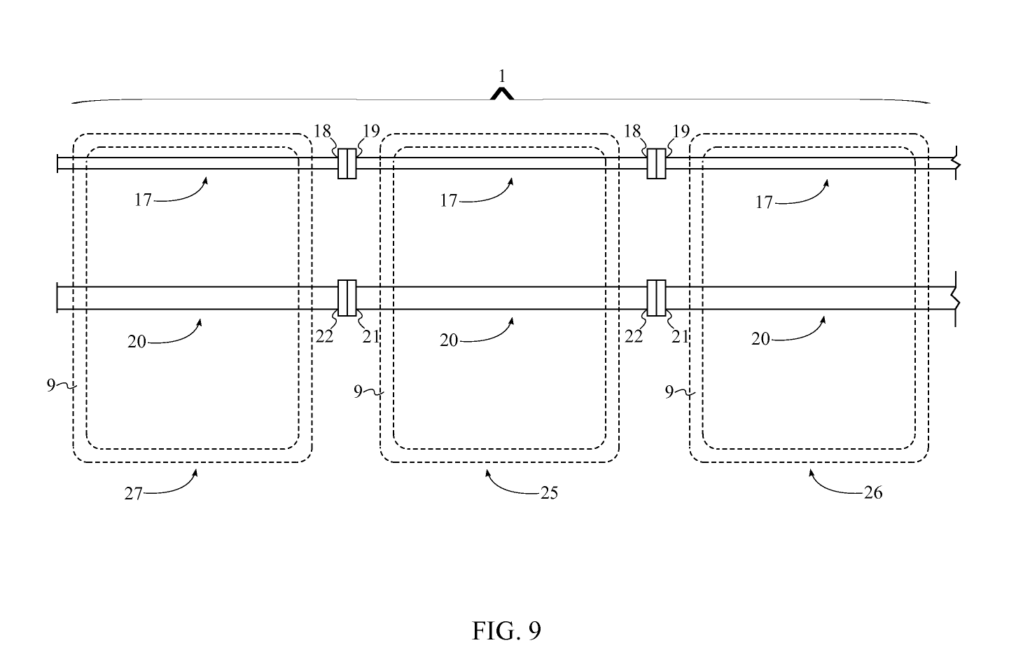

As shown in FIG. 8 and FIG. 9, multiple of the present invention may be connected together in order to create a large growing system. In the preferred embodiment of the present invention, the distribution pipe 17 is positioned parallel to the return pipe 20 in order to facilitate the connection between multiple of the present invention in sequence. The distribution pipe 17 comprises a distribution inlet 18 and a distribution outlet 19. The distribution inlet 18 is the end of the distribution pipe 17 from which water and nutrients enters the distribution pipe 17 when being directed to the at least one spray nozzle assembly 6. The distribution outlet 19 is the end of the distribution pipe 17 through which water and nutrients exits the distribution pipe 17. Similarly, the return pipe 20 comprises a return inlet 21 and a return outlet 22. The return inlet 21 is the end of the return pipe 20 through which water and nutrients enters the return pipe 20 when returning to the fluid reservoir 28. The return outlet 22 is the end of the return pipe 20 through which water and nutrients exits the return pipe 20. In the embodiment of the present invention shown in FIG. 8, the at least one aeroponic assembly 1 is a plurality of aeroponic assemblies. The plurality of aeroponic assemblies comprises a first aeroponic assembly 23 and a second aeroponic assembly 24. The pump 29 is in fluid communication with the distribution inlet 18 of the first aeroponic assembly 23. Water and nutrients in the fluid reservoir 28 are directed into the distribution inlet 18 of the first aeroponic assembly 23 by the pump 29. The distribution outlet 19 of the first aeroponic assembly 23 is in fluid communication with the distribution inlet 18 of the second aeroponic assembly 24. This allows the pump 29 to direct water and nutrients into the second aeroponic assembly 24 as well as the first aeroponic assembly 23. The return outlet 22 of the second aeroponic assembly 24 is in fluid communication with the return inlet 21 of the first aeroponic assembly 23, allowing remaining water and nutrients from the second aeroponic assembly 24 to exit into the first aeroponic assembly 23. The return outlet 22 of the first aeroponic assembly 23 is in fluid communication with the fluid reservoir 28 and as such, remaining water and nutrients from both the first aeroponic assembly 23 and the second aeroponic assembly 24 are returned to the fluid reservoir 28. In this embodiment of the present invention, the distribution outlet 19 of the second aeroponic assembly 24 and the return inlet 21 of the second aeroponic assembly 24 are plugged or otherwise sealed as the second aeroponic assembly 24 is not connected to an additional aeroponic assembly beyond the first aeroponic assembly 23.

Multiple of the present invention may be connected together beyond the first aeroponic assembly 23 and the second aeroponic assembly 24 shown in FIG. 8. In the embodiment of the present invention shown in FIG. 9, the at least one aeroponic assembly 1 is a plurality of aeroponic assemblies. The plurality of aeroponic assemblies comprising an arbitrary aeroponic assembly 25, a preceding aeroponic assembly 26, and a subsequent aeroponic assembly 27. The arbitrary aeroponic assembly 25 is any aeroponic assembly along the plurality of aeroponic assemblies and is positioned in between the preceding aeroponic assembly 26 and the subsequent aeroponic assembly 27. The distribution outlet 19 of the preceding aeroponic assembly 26 is in fluid communication with the distribution inlet 18 of the arbitrary aeroponic assembly 25. Water and nutrients from the preceding aeroponic assembly 26 are thus directed into the arbitrary aeroponic assembly 25. Similarly, the distribution outlet 19 of the arbitrary aeroponic assembly 25 is in fluid communication with the distribution inlet 18 of the subsequent aeroponic assembly 27. This allows the water and nutrients to be directed from the arbitrary aeroponic assembly 25 into the subsequent aeroponic assembly 27. The return outlet 22 of the subsequent aeroponic assembly 27 is in fluid communication with the return inlet 21 of the arbitrary aeroponic assembly 25. This allows the remaining water and nutrients from the subsequent aeroponic assembly 27 to be directed into the arbitrary aeroponic assembly 25. Similarly, the return outlet 22 of the arbitrary aeroponic assembly 25 is in fluid communication with the return inlet 21 of the preceding aeroponic assembly 26. As such, water and nutrients from the subsequent aeroponic assembly 27 are able to pass through both the arbitrary aeroponic assembly 25 and the preceding aeroponic assembly 26 when returning to the fluid reservoir 28.

Although the present invention has been explained in relation to its preferred embodiment, it is understood that many other possible modifications and variations can be made without departing from the spirit and scope of the present invention as hereinafter claimed.

What is claimed is:

1. An aeroponic and drip gardener system comprises:
an at least one aeroponic assembly;
a fluid reservoir;
a pump;
the at least one aeroponic assembly comprises an aeroponic container, an at least one spray nozzle assembly, a structural base, a drainage system, a distribution pipe, and a return pipe;
the pump being mounted within the fluid reservoir;
the fluid reservoir being in fluid communication with the distribution pipe through the pump;
the distribution pipe being in fluid communication with the at least one spray nozzle assembly;
the at least one spray nozzle assembly being mounted within the aeroponic container;
the drainage system being integrated between the aeroponic container and the structural base; and
the drainage system being in fluid communication with the fluid reservoir through the return pipe.

2. The aeroponic and drip gardener system as claimed in claim 1 further comprises:
a feed tube assembly;
the feed tube assembly comprises a feed inlet pipe and a feed outlet pipe;
the feed tube assembly being externally mounted to the at least one aeroponic assembly;
the distribution pipe being in fluid communication with the feed inlet pipe;
the feed inlet pipe being in fluid communication with the feed outlet pipe;
the feed inlet pipe being detachably and hermetically coupled to the feed outlet pipe; and
the feed outlet pipe being in fluid communication with the at least one spray nozzle assembly.

3. The aeroponic and drip gardener system as claimed in claim 1 further comprises:
the drainage system comprises a plurality of drainage holes, a drainage lid, a water-collection cavity, and a lid hole;
the aeroponic container comprises a container base;
the drainage lid being mounted onto the structural base;
the plurality of drainage holes traversing through the container base;
the plurality of drainage holes being distributed across the container base;
the water-collection cavity traversing into the drainage lid;
the lid hole traversing through the drainage lid from the water-collection cavity;
the lid hole being in fluid communication with the return pipe; and
the aeroponic container being mounted onto the drainage lid, adjacent to the water-collection cavity.

4. The aeroponic and drip gardener system as claimed in claim 1 further comprises:
the drainage system comprises a drainage lid;
the structural base being an open-ended vessel;
the open-ended vessel comprises a vessel open end and a vessel lip;
the vessel lip being laterally positioned around the vessel open end; and
the drainage lid being seated onto the vessel lip.

5. The aeroponic and drip gardener system as claimed in claim 1 further comprises:
an aeroponic lid;
the aeroponic container comprises a container open end and a container lip;
the container lip being laterally positioned around the container open end; and
the aeroponic lid being seated onto the container lip.

6. The aeroponic and drip gardener system as claimed in claim 1 further comprises:
an aeroponic lid;
a plant-supporting gasket;
the plant-supporting gasket being positioned centrally on the aeroponic lid;
the plant-supporting gasket traversing into the aeroponic container through the aeroponic lid; and
the plant-supporting gasket being removably attached to the aeroponic lid.

7. The aeroponic and drip gardener system as claimed in claim 1 further comprises:
the at least one spray nozzle assembly comprises a first spray nozzle assembly and a second spray nozzle assembly;
the first spray nozzle assembly and the second spray nozzle assembly being positioned opposite to each other across the aeroponic container; and
the first spray nozzle assembly and the second spray nozzle assembly being oriented toward each other.

8. The aeroponic and drip gardener system as claimed in claim 1 further comprises:
the intake pipe being positioned parallel to the return pipe.

9. The aeroponic and drip gardener system as claimed in claim 1 further comprises:
the distribution pipe comprises a distribution inlet and a distribution outlet;
the return pipe comprises a return inlet and a return outlet;
the at least one aeroponic assembly being a plurality of aeroponic assemblies;
the plurality of aeroponic assemblies comprises a first aeroponic assembly and a second aeroponic assembly;
the pump being in fluid communication with the distribution inlet of the first aeroponic assembly;
the distribution outlet of the first aeroponic assembly being in fluid communication with the distribution inlet of the second aeroponic assembly;
the return outlet of the second aeroponic assembly being in fluid communication with the return inlet of the first aeroponic assembly; and
the return outlet of the first aeroponic assembly being in fluid communication with the fluid reservoir.

10. The aeroponic and drip gardener system as claimed in claim 1 further comprises:
the distribution pipe comprises a distribution inlet and a distribution outlet;
the return pipe comprises a return inlet and a return outlet;
the at least one aeroponic assembly being a plurality of aeroponic assemblies;
the plurality of aeroponic assemblies comprises an arbitrary aeroponic assembly, a preceding aeroponic assembly, and a subsequent aeroponic assembly;
the distribution outlet of the preceding aeroponic assembly being in fluid communication with the distribution inlet of the arbitrary aeroponic assembly;
the distribution outlet of the arbitrary aeroponic assembly being in fluid communication with the distribution inlet of the subsequent aeroponic assembly;
the return outlet of the subsequent aeroponic assembly being in fluid communication with the return inlet of the arbitrary aeroponic assembly; and
the return outlet of the arbitrary aeroponic assembly being in fluid communication with the return inlet of the preceding aeroponic assembly.

11. An aeroponic and drip gardener system comprises:
an at least one aeroponic assembly;
a fluid reservoir;
a pump;
the at least one aeroponic assembly comprises an aeroponic container, an at least one spray nozzle assembly, a structural base, a drainage system, a distribution pipe, and a return pipe;
the drainage system comprises a plurality of drainage holes, a drainage lid, a water-collection cavity, and a lid hole;
the aeroponic container comprises a container base;
the pump being mounted within the fluid reservoir;
the fluid reservoir being in fluid communication with the distribution pipe through the pump;
the distribution pipe being in fluid communication with the at least one spray nozzle assembly;
the at least one spray nozzle assembly being mounted within the aeroponic container;
the drainage system being integrated between the aeroponic container and the structural base;
the drainage system being in fluid communication with the fluid reservoir through the return pipe;
the drainage lid being mounted onto the structural base;
the plurality of drainage holes traversing through the container base;
the plurality of drainage holes being distributed across the container base;
the water-collection cavity traversing into the drainage lid;
the lid hole traversing through the drainage lid from the water-collection cavity;
the lid hole being in fluid communication with the return pipe; and
the aeroponic container being mounted onto the drainage lid, adjacent to the water-collection cavity.

12. The aeroponic and drip gardener system as claimed in claim 11 further comprises:
a feed tube assembly;
the feed tube assembly comprises a feed inlet pipe and a feed outlet pipe;
the feed tube assembly being externally mounted to the at least one aeroponic assembly;
the distribution pipe being in fluid communication with the feed inlet pipe;
the feed inlet pipe being in fluid communication with the feed outlet pipe;
the feed inlet pipe being detachably and hermetically coupled to the feed outlet pipe; and
the feed outlet pipe being in fluid communication with the at least one spray nozzle assembly.

13. The aeroponic and drip gardener system as claimed in claim 11 further comprises:
an aeroponic lid;
the aeroponic container comprises a container open end and a container lip;
the structural base being an open-ended vessel;
the open-ended vessel comprises a vessel open end and a vessel lip;
the vessel lip being laterally positioned around the vessel open end;
the drainage lid being seated onto the vessel lip;
the container lip being laterally positioned around the container open end; and
the aeroponic lid being seated onto the container lip.

14. The aeroponic and drip gardener system as claimed in claim 11 further comprises:
an aeroponic lid;
a plant-supporting gasket;
the plant-supporting gasket being positioned centrally on the aeroponic lid;
the plant-supporting gasket traversing into the aeroponic container through the aeroponic lid; and
the plant-supporting gasket being removably attached to the aeroponic lid.

15. The aeroponic and drip gardener system as claimed in claim 11 further comprises:
the at least one spray nozzle assembly comprises a first spray nozzle assembly and a second spray nozzle assembly;
the first spray nozzle assembly and the second spray nozzle assembly being positioned opposite to each other across the aeroponic container; and
the first spray nozzle assembly and the second spray nozzle assembly being oriented toward each other.

16. The aeroponic and drip gardener system as claimed in claim 11 further comprises:
the intake pipe being positioned parallel to the return pipe.

17. The aeroponic and drip gardener system as claimed in claim 11 further comprises:
the distribution pipe comprises a distribution inlet and a distribution outlet;
the return pipe comprises a return inlet and a return outlet;
the at least one aeroponic assembly being a plurality of aeroponic assemblies;
the plurality of aeroponic assemblies comprises a first aeroponic assembly and a second aeroponic assembly;
the pump being in fluid communication with the distribution inlet of the first aeroponic assembly;
the distribution outlet of the first aeroponic assembly being in fluid communication with the distribution inlet of the second aeroponic assembly;
the return outlet of the second aeroponic assembly being in fluid communication with the return inlet of the first aeroponic assembly; and
the return outlet of the first aeroponic assembly being in fluid communication with the fluid reservoir.

18. The aeroponic and drip gardener system as claimed in claim 11 further comprises:
the distribution pipe comprises a distribution inlet and a distribution outlet;
the return pipe comprises a return inlet and a return outlet;
the at least one aeroponic assembly being a plurality of aeroponic assemblies;
the plurality of aeroponic assemblies comprises an arbitrary aeroponic assembly, a preceding aeroponic assembly, and a subsequent aeroponic assembly;
the distribution outlet of the preceding aeroponic assembly being in fluid communication with the distribution inlet of the arbitrary aeroponic assembly;
the distribution outlet of the arbitrary aeroponic assembly being in fluid communication with the distribution inlet of the subsequent aeroponic assembly;
the return outlet of the subsequent aeroponic assembly being in fluid communication with the return inlet of the arbitrary aeroponic assembly; and
the return outlet of the arbitrary aeroponic assembly being in fluid communication with the return inlet of the preceding aeroponic assembly.
